(19) United States
(12) Patent Application Publication
(10) Pub. No.: US 2007/0097291 A1
(43) Pub. Date: May 3, 2007

(54) Polymer dispersed liquid crystal

(75) Inventors: David A. Champion, Lebanon, OR (US); Charles E. Otis, Corvallis, OR (US); Chinmay S. Betrabet, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, LP

(21) Appl. No.: 11/263,524

(22) Filed: Oct. 31, 2005

(51) Int. Cl. G02F 1/1333

(52) U.S. Cl. 349/86

(57) ABSTRACT

Various embodiments of a display including a near UV light source, a photo luminescent material and a polymer dispersed liquid crystal sandwiched there on a bitch between having liquid droplets with a diameter of less than or equal to about 800 nm are disclosed.

### BACKGROUND

Many displays attenuate visible light with liquid crystals or with polymer dispersed liquid crystals. Displays using liquid crystals suffer from viewing degradation, light loss and pressure sensitivity. Displays using polymer dispersed liquid crystals may have relatively low contrast ratios.

### BRIEF DESCRIPTION OF THE DRAWINGS

FIG. 1 is a schematic illustration of an embodiment of a display according to one example embodiment.

FIG. 2 is a graph illustrating Polymer Dispersed Liquid Crystal (PDLC) transmittance over a range of different wavelengths as a function of applied voltage according to one example embodiment.

FIG. 3 is a graph illustrating PDLC transmittance of electromagnetic wavelengths at a zero applied voltage according to one example embodiment.

FIG. 4 is an exploded perspective view schematically illustrating another embodiment of the display of FIG. 1 according to an example embodiment.

FIG. 5 is an enlarged fragmentary plan view of an electrode matrix of the display of FIG. 4 according to an example embodiment.

FIG. 6 is an enlarged view of the electrode matrix of FIG. 5 taken along line 6-6 according to an example embodiment.

FIG. 7 is a fragmentary sectional view of an assembled portion of the display of FIG. 4 according to an example embodiment.

FIG. 8 is an enlarged fragmentary plan view of a PDLC matrix of the display of FIG. 4 according to an example embodiment.

FIG. 9 is an enlarged fragmentary plan view of a photo luminescent matrix of the display of FIG. 4 according to an example embodiment.

FIG. 10 is a fragmentary sectional view of a portion of another embodiment of the display of FIG. 1 according to an example embodiment.

### DETAILED DESCRIPTION OF EXAMPLE EMBODIMENTS

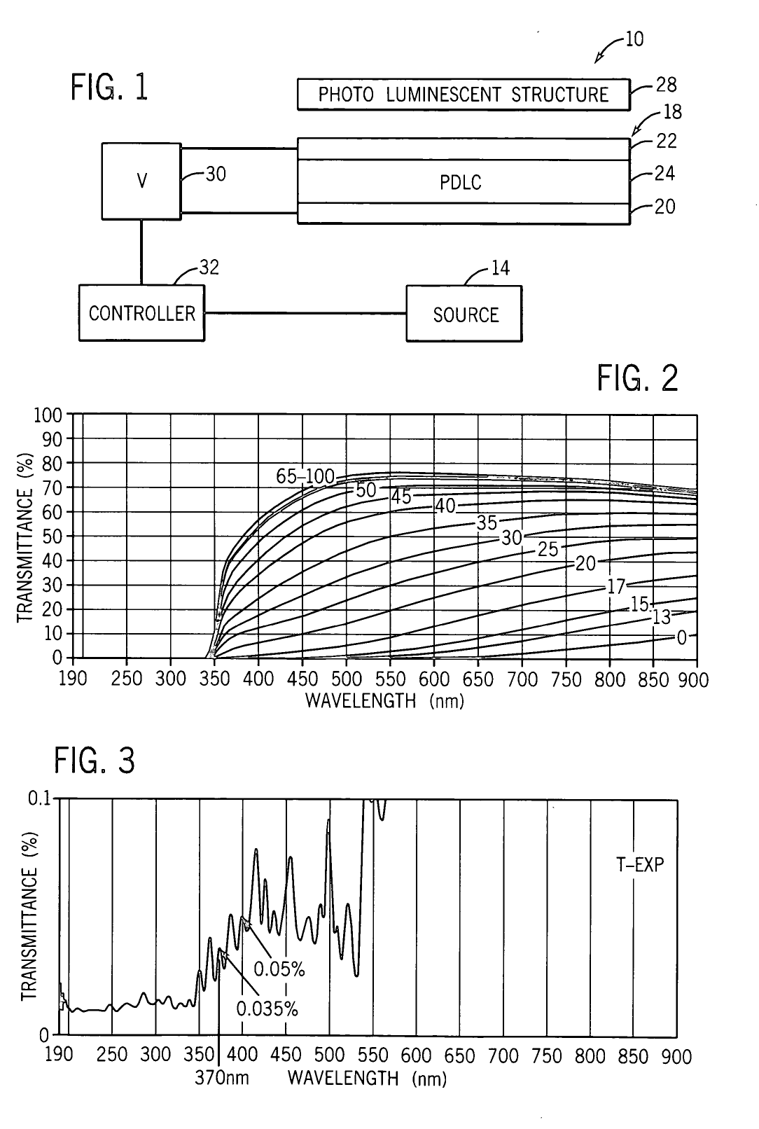

FIG. 1 schematically illustrates display system 10 which generally includes near-UV light source 14, modulator 18, photo luminescent structure 28, voltage source 30 and controller 32. Near-UV light source 14 comprises a source of near-UV light. For purposes of this disclosure, the term “near-UV light” shall mean a light or electromagnetic energy having wavelengths of between about 360 nm and about 420 nm. According to one embodiment, source 14 is configured to emit a portion of the electromagnetic spectrum including wavelengths of between about 360 nanometers and about 500 nanometers and nominally between about 370 nanometers and 410 nanometers. In one embodiment, source 14 may comprise light-emitting diodes. In another embodiment, light source 14 may comprise tubes or other sources for near-UV light. According to one embodiment, near-UV light source 14 includes InGaN light emitting diodes configured to emit near-UV light at a wavelength of about 400 nanometers.

Photo luminescent structure 28 comprises one or more layers of one or more photo luminescent materials which are configured to emit a second portion of the electromagnetic spectrum, such as visual light, in response to being impinged by near-UV light from source 14. In one embodiment, photo luminescent structure 28 compromises a color change material such as one or more color phosphors. For example, in one embodiment, photo luminescent structure 28 may be configured to down convert UV light into light having wavelength within a visible spectrum such as red, green and blue. According to one embodiment, photo luminescent structure 28 may be formed from a perylene-based organic color change material which provides saturated color emission, high fluorescence quantum efficiency and acceptable “light-fastness.” In one embodiment, photo luminescent structure 28 comprises L-184 supplied by BEAVER LUMINESCERS.

Modulator 18 comprises a mechanism located between source 14 and photo luminescent structure 28 that is configured to selectively attenuate or shutter light from source 14. Modulator 18 actuates between different transmissive states based upon voltage applied by voltage source 30 as controlled by controller 32. Modulator 18 generally includes conductors 20, 22 and polymer dispersed liquid crystal (PDLC) 24. Conductors 20 and 22 comprise one or more layers of transparent electrically conductive material between which is sandwiched PDLC 24. Conductors 20 and 22 are configured to be connected to voltage source 30 so as to create an electrical field across PDLC 24 to actuate PDLC 24 to different light transmissive states. According to one embodiment, conductors 20 and 22 may be formed from a transparent electrically conductive material such as indium tin oxide. In other embodiments, conductors 20 and 22 may be formed from other transparent or translucent electrically conductive materials.

PDLC 24 comprises a layer of polymer dispersed liquid crystal material sandwiched between conductors 20 and 22. PDLC 24 is configured to selectively block or attenuate light based upon the electric field present across PDLC 24. PDLC 24 is configured to attenuate light or electromagnetic radiation having a wavelength of less than or equal to about 480 nanometers at a higher rate as compared to electromagnetic radiation having wavelengths greater than 500 nanometers. PDLC 24 is configured to absorb light from light source 14 having wavelengths of less than or equal to about 500 nanometers. In one embodiment, PDLC 24 includes liquid crystal droplets having individual diameters of less than or equal to about 800 nanometers. In other embodiments, PDLC 24 includes liquid crystal droplets having individual diameters of less than or equal to about 500 nanometers. The reduced diameters of the liquid crystal droplets enhances absorption of PDLC 24 of near-UV light. This enhanced absorption may enable PDLC 24 to provide display system 10 with greater contrast.

According to one example embodiment, PDLC 24 is formed by combining a pre-polymer and liquid crystals to form a mixture followed by the addition of a polymerization agent and curing the mixture to form liquid crystal droplets having a diameter of less than or equal to about 800 nanometers. In particular, according to one example embodiment, a liquid crystal and a pre-polymer are mixed in a desired ratio by stirring at room temperature until homogenous.

In one embodiment, the pre-polymer includes a mixture of a photo activator and a monomer. According to one example embodiment, the photo activator may comprise 10.5% by weight MXM035 part A, commercially available from Merck Specialty Chemicals Ltd, South Hampton, England. In such an embodiment, the monomer may comprise 89.5% by weight MXM035 part B, commercially available from Merck Specialty Chemicals Ltd., South Hampton, England. According to one embodiment, this pre-polymer is subsequently mixed with liquid crystal to a point of saturation. In one example embodiment, the liquid crystal may comprise BL035, commercially available from Merck Specialty Chemicals Ltd., South Hampton, England. The pre-polymer and the liquid crystal are mixed such that the liquid crystal has a weight percentage of the resulting pre-polymer/liquid crystal mixture of at least about 55%. In one embodiment, the liquid crystal such as BL035, is mixed with the pre-polymer (MXM035 parts A and B) to substantially complete saturation at room temperature (20° C.) of about 60% by weight. In some embodiments, the solubility of the liquid crystal in the pre-polymer is increased to above 60% by weight by additional methods such as by heating the pre-polymer to above 20° C. The resulting mixture is stirred until substantially clear.

Upon completion of preparation of the mixture, the mixture is spread to a thickness of between about 2 micrometers and 20 micrometers. In one embodiment, the mixture of the pre-polymer and liquid crystal is dispensed into a suitable cell by capillary action. The cell may be formed from glass coated with a material such as indium tin oxide, wherein the cell gaps are between 2 microns and 20 microns. Alternatively, the liquid crystal/pre-polymer mixture may be coated onto a substrate such as indium tin oxide coated glass or plastic or other techniques such as bar or doctor blade coating.

Once the liquid crystal/pre-polymer mixture has been spread to a thickness of between 2 microns and about 20 microns, the mixture is subsequently cured by exposing the mixture to ultraviolet light. According to one embodiment, curing is performed under conditions of controlled temperature and UV power. In one embodiment, curing is performed in a range of 22 to 30 degrees C. with a lamp intensity at a substrate of at least about 1.5 W/cm² and less than or equal to about 5.5 W/cm² at a UV wavelength of 315 to 400 nanometers for a time of between about 1 and about 3 seconds. According to one embodiment, a post cure at lower lamp power may be performed to provide for full cure. In one embodiment, the process is complete when the mixture is no longer transitioning from a nematic liquid crystal phase to an isotropic liquid crystal phase. Although the example PDLC 24 has been described as being formed according to the above described process, PDLC 24 may alternatively be formed using other materials, other mixtures or proportions, other curing rates, and in other fashions.

In one embodiment, coating of the liquid crystal/pre-polymer mixture may be upon an open substrate. In such an embodiment, curing of the mixture is performed in an inert atmosphere to inhibit atmospheric oxygen. A second substrate including conductor 46 and conductor 48 may be subsequently laminated to the film resulting from curing of the mixture.

FIGS. 2 and 3 are graphs illustrating spectral transmission response of one embodiment of PDLC 24, as formed according to the above process, at various voltages. In the particular example illustrated, a DC voltage is applied. In other embodiments, a AC voltage may alternatively be used. As shown by the graph in FIG. 2, PDLC 24 strongly attenuates light having a wavelength of about 525 nanometers when a zero voltage is applied. As shown by the graph of FIG. 2, even with an applied voltage of 15 volts, PDLC strongly attenuates light having a wavelength of less than about 450 nanometers. As shown by the graph in FIG. 3, when a zero voltage is applied across PDLC 24, PDLC 24 strongly attenuates light having a wavelength of less than about 400 nanometers. As a result, PDLC 24 may achieve a relatively high percentage transmittance with an applied voltage and a relatively low transmittance in the absence or lessening of the applied voltage. The ratio of the transmittance under a voltage as compared to transmittance without a voltage or with a lessened voltage is sometimes referred to as contrast. As shown by FIG. 3, PDLC 24 will attenuate a 370 nanometer light at an off-state or zero voltage such that about 0.035% of such light passes through PDLC 24. As shown by FIG. 2, PDLC 24 will exhibit a transmittance of 20% when 35 volts are applied across PDLC 24, resulting in a contrast ratio of 570:1. PDLC 24 will exhibit a transmittance of 40% when 65 volts are applied across PDLC 24, resulting in a contrast ratio of 1140:1.

As shown by FIG. 3, for light having a wavelength of 400 nanometers, PDLC 24 exhibits a 0.05% transmittance when in an off-state (i.e., zero volts are applied across PDLC 24). As shown by FIG. 2, having a wavelength of 400 nanometers, PDLC 24 exhibits a transmittance of about 20% upon application of 30 volts, resulting in a contrast ratio of 400:1. Simple contrast ratio is defined as maximum transmission/minimum transmission. As further shown by the graph of FIG. 2, for light having a wavelength of 400 nanometers, PDLC 24 exhibits a transmittance of about 40% in response to 40 volts being applied across PDLC 24, resulting in a contrast ratio of 800:1. As shown by the graphs in FIGS. 2 and 3, the particular example of PDLC 24 facilitates high contrast ratios at relatively low voltages.

As shown by FIG. 1, voltage source 30 is electrically connected to conductors 20 and 22. Voltage source 30 is configured to selectively apply a voltage to one or both of conductors 20 and 22 to selectively vary the transmittance of PDLC 24. Controller 32 comprises a processing unit configured to generate control signals for directing voltage source 30 to selectively apply conductors 20 and 22 to vary the transmittance of PDLC 24. For purposes of disclosure, the term “processing unit” shall mean a presently available or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 32 is not limited to any specific combination of hardware circuitry and software, nor to any particular source for the instructions executed by the processing unit. In the particular example illustrated, controller 32 is further configured to generate control signals directing the operation of light source 14.

In operation, light source 14 emits a portion of the electromagnetic spectrum. In the particular example shown, light source 14 emits light having wavelengths of between about 370 and 400 nanometers. Controller 32 generates control signals directing voltage source 30 to create a voltage across PDLC 24 to actuate PDLC 24 between various levels of transmittance depending upon a desired intensity to be emitted by display system 10. When zero volts is applied across PDLC 24, PDLC 24 substantially attenuates the light from light source 14 prior to such light reaching photo luminescent structure 28. As a result, photo luminescent structure 28 emits little if any light and display system 10 is substantially dark. When controller 32 generates control signals directing voltage source 30 to create a voltage across PDLC 24, PDLC 24 exhibits a higher transmittance such that light from light source 14 passes through PDLC 24 to photo luminescent structure 28. As a result, photo luminescent structure 28 emits a second portion of the electromagnetic spectrum, such as visible light, resulting in display system 10 also emitting visible light. In particular embodiments, photo luminescent structure 28 may be configured to emit selected wavelengths or colors of light upon being impinged by light from light source 14. In particular embodiments, display system 10 may include a multitude of modulator pixels or cells such as modulator 18 and may also include a corresponding multitude of photo luminescent pixels or cells.

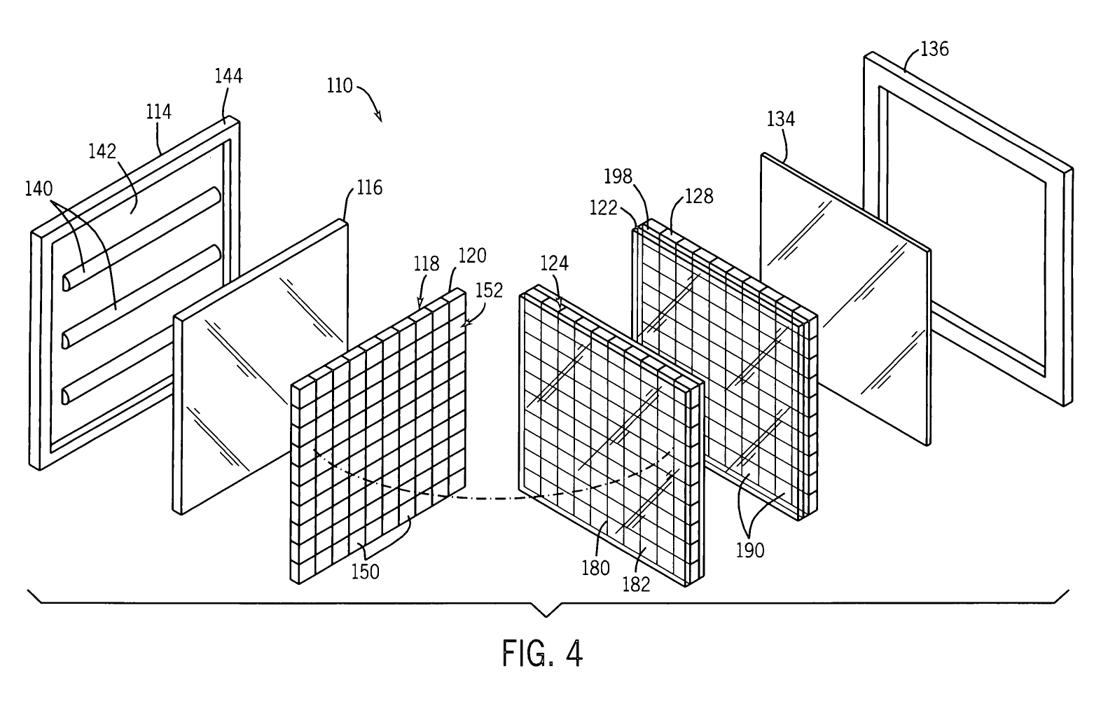

FIG. 4 is an exploded perspective view of display 110, another embodiment of display system 10 shown and described with respect to FIG. 1. Display 110 generally includes a UV-light source 114, diffuser 116, modulator 118, which includes electrode matrix 120, electrode 122 and PDLC matrix 124, photo luminescent matrix 128, protective film 134, and frame 136. Light source 114 comprises a device configured to emit near-UV light in a direction towards photo luminescent matrix 128. In the particular example illustrated, light source 114 includes ultraviolet light-emitting tubes 140 secured to a support 142 which is bound by a frame 144. In other embodiments, light source 114 may alternatively include tubes configured to emit light having wavelengths proximate to the ultraviolet wavelengths. In still other embodiments, light source 114 may alternatively include light emitting diodes configured to emit near-UV light.

Diffuser 116 comprises a sheet or layer of translucent material configured to diffuse light emitted by light source 114 to distribute the light across the display. In particular embodiments, a second panel (not shown) (from NITTO DENKO Group, OPTMATE Corp as an example) may be provided which collimates the light so that it enters normal to the surface plane of the display. In the particular embodiment shown, diffuser 116 comprises a translucent plastic such as Illuminex diffuser film commercially available from GE Advanced Materials. In other embodiments, diffuser 116 may comprise other materials or may be omitted.

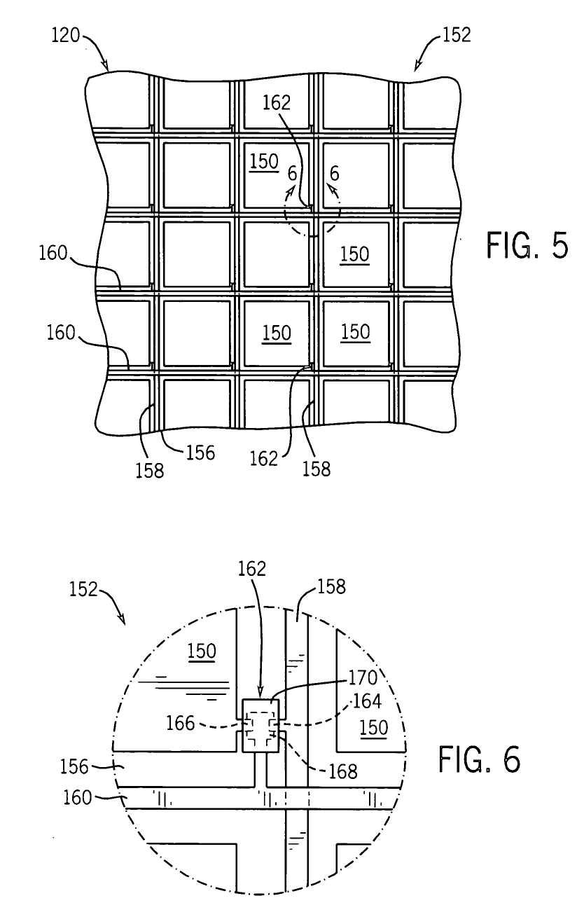

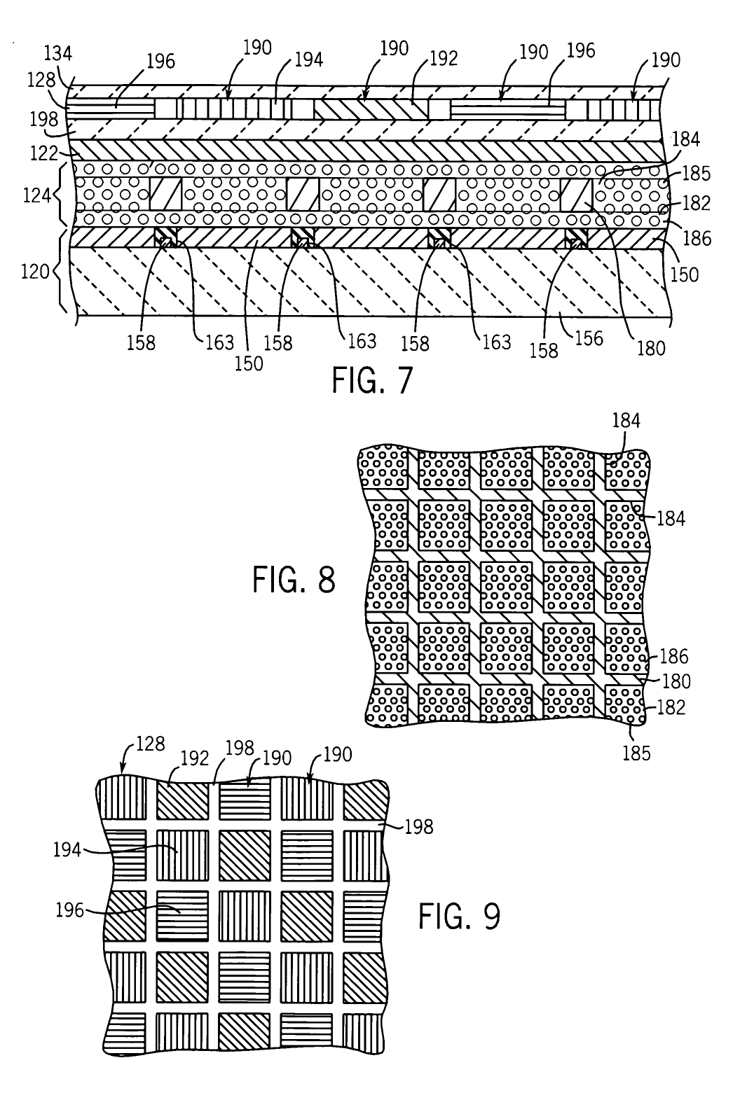

Electrode matrix 120 comprises an assembly including a plurality of independently or selectively chargeable electrodes 150 (schematically shown in FIG. 4). Electrodes 150 are configured to be independently charged to distinct voltages and cooperate with electrode 122 to selectively actuate distinct portions of PDLC matrix 124 between different transmissive states. FIGS. 5 and 6 illustrate face 152 of electrode matrix 120 in greater detail. FIG. 7 is a sectional view illustrating matrix 120 in greater detail, as well illustrating electrode 122, matrix 124, matrix 128 and film 134 as assembled. As shown by FIGS. 5-7, in addition to electrodes 150, electrode matrix 120 includes substrate 156, data lines 158, signal lines 160 and switching devices 162. Electrodes 150 comprise platelets or panels of transparent electrically conductive material, such as indium tin oxide, arranged across face 152. Electrodes 150 are electrically separated or partitioned from one another by dielectric breaks 163 (shown in FIG. 7). In the particular example illustrated, breaks 163 comprise portions of dielectric material, such as silicon, extending around and between electrodes 150. Breaks 163 are omitted in FIGS. 5 and 6 for purposes of illustrating lines 158 and 160. In other embodiments, breaks 163 may comprise gaps between electrodes 150. Although, in the particular embodiment illustrated, electrodes 150 are illustrated as having a square geometry and as being arranged in a series of linearly arranged rows and columns, electrodes 150 may alternatively have other shapes or other surface geometries and may be arranged in other orders or relative positions along face 152. In other embodiments, electrodes 150 may be formed from other transparent electrically conducted materials.

Substrate 156 comprises one or more layers of transparent dielectric material configured to support electrodes 150, data lines 158, signals lines and switching devices 162. In one embodiment, substrate 156 may comprise glass. In another embodiment, substrate 156 may comprise one or more layers of a polymeric or plastic material.

Data lines 158 comprise electrically conductive lines or traces of one or more electrically conductive materials carried or formed upon substrate 156. In other embodiments, lines 158 may be formed within the material or materials of breaks 163. Data lines 158 are electrically connected to a voltage source, such as voltage source 30 shown and described with respect to FIG. 1, and are selectively connectable to each of electrodes 150 by switching devices 162. Data lines 158 supply charge to electrodes 150 to establish a voltage across PDLC matrix 124 as will be described hereafter.

Signal lines 160 comprise electrically conductive lines or traces carried or formed upon substrate 156. In other embodiments, lines 160 may be formed within the material or materials of breaks 163. Signal lines 160 are configured to be selectively connected to a voltage source, such as voltage source 30 shown and described with respect to FIG. 1, by a controller, such as controller 32. Signal lines 160 are further electrically connected to switching device 162. Signal lines 160 are configured to apply a charge to switching device 162 so as to actuate switching device 162 between a first electrically conductive state in which charge from data line 158 is transmitted to electrode 150 and a second open state in which charge from data line 158 is not transmitted to electrode 150.

Switching devices 162 comprise devices configured to selectively transmit charge from data lines 158 to electrodes 150 based upon signal voltages received via signal lines 160. In the particular example illustrated in FIG. 6, switching devices 162 each comprise a thin film transistor arrangement including a source electrode 164 electrically connected to data line 158, a drain electrode 166 electrically connected to electrode 150, a gate electrode 168 (shown in hidden lines) electrically connected to signal line 160 and a semiconductive material 170 interposed between source electrode 164, drain electrode 166 and gate electrode 168. In other embodiments, switching device 162 may comprise a metal-insulator-metal device or other switching devices. In still other embodiments, in lieu of including an active matrix control arrangement, electrode matrix 120 may alternatively include a passive control arrangement for each of electrodes 150, wherein switching devices for actuating electrodes 150 between different voltage levels are grouped together along a perimeter or at another location outside of electrode matrix 120.

Electrode 122 generally comprises one or more continuous layers or sheets of transparent electrically conductive material extending opposite to electrode matrix 120 with PDLC matrix 124 therebetween. Electrode 122 cooperates with electrodes 150 of electrode matrix 120 to create a voltage across PDLC matrix 124 to actuate portions of PDLC matrix 124 between different transmissive states. In one particular embodiment, electrode 122 is electrically connected to ground. In other embodiments, electrode 122 may be charged. In one embodiment, electrode 122 is formed from an electrically conductive material such as indium tin oxide. In other embodiments, electrode 122 may be formed from other transparent electrically conductive materials.

PDLC matrix 124 is sandwiched between electrode matrix 120 and electrode 122. As shown by FIGS. 7 and 8, PDLC matrix 124 generally includes grid 180 and PDLC 182. Grid 180 comprises a series of dielectric near-UV light absorbing walls which substantially partition PDLC 182 into a plurality of cells or pixels 184. As shown by FIG. 7, such cells or pixels 184 are generally aligned with corresponding electrodes 150 of electrode matrix 120. In particular, the walls of grid 180 are aligned with and extend opposite to the dielectric breaks 163 separating electrodes 150. The walls of grid 180 attenuate the transmission of near-UV light passing through PDLC 182 in one cell 184, that has been actuated to a transmissive state, into an adjacent cell 184 containing PDLC 182 which is intended to be in a lesser transmissive state. In other words, grid 180 reduces visual cross talk between portions of PDLC 182 that are in different transmissive states due to different applied voltages by their respective electrodes 150. In the particular example shown in which grid 180 also extends opposite to dielectric breaks 163 between electrodes 150, grid 180 also serves to hide or block data lines 158, signal lines 160 and switching devices 162 (shown in FIG. 6). Although grid 180 is illustrated as forming rectangular or square cells 184, wherein each cell has substantially the same dimensions, grid 180 may alternatively be configured to form cells 184 having other shapes and cells 184 having different uniform or non-uniform dimensions.

In the particular example illustrated, grid 180 comprises a screen-like panel formed from a flexible dielectric material such as black anodized aluminum. In other embodiments, grid 180 may alternatively be formed from other dielectric light absorbing materials such as black polymers. In the particular example illustrated, grid 180 has a substantially uniform depth across its length and width. The depth is at least 2 microns, less than or equal to about 20 microns and nominally about 8 microns. In other embodiments, grid 180 may have other dimensions. In some embodiments, grid 180 may be omitted.

PDLC 182 comprises a polymer dispersed liquid crystal material having liquid crystal droplets 185 to disperse throughout a polymer 186. Such liquid crystal droplets have a diameter of less than or equal to about 800 nanometers and nominally less than or equal to about 500 nanometers. In one embodiment, PDLC 182 may be formed according to the above-described procedure as set forth with respect to PDLC 24.

According to one embodiment, grid 180 is formed within PDLC 182 prior to the curing of the pre-polymer/liquid crystal mixture. In one embodiment, grid 180 is immersed within a layer of liquid pre-polymer/liquid crystal mixture. The mixture encapsulating grid 180 is subsequently cured at a rate such that the liquid crystal forms droplets having individual diameters less than or equal to about 800 nanometers and nominally less than or equal to about 500 nanometers. This process enables cells 184 or grid 180 to be quickly filled with the mixture that forms PDLC 182 upon being cured. This process may result in PDLC 182 continuously extending from one cell 184 to an adjacent cell 184 across grid 180. In other embodiments, the pre-polymer/liquid crystal mixture may be applied across grid 180. In still other embodiments, cells 184 may be individually or collectively filled with the pre-polymer/liquid crystal mixture prior to curing without the mixture flowing over or extending above the walls of grid 180. In still other embodiments, PDLC 182 may be deposited within cells 184 after the initial pre-polymer/liquid crystal mixture is cured.

As shown by FIG. 4, photo luminescent matrix 128 includes a plurality of pixels 190 (schematically shown in FIG. 4) of photo luminescent material across and opposite to cells 184 containing a PDLC 182. In other embodiments, pixels 190 may be formed from a photo luminescent material such as a perylene-based organic color change material. In other embodiments, pixels 190 may be formed from other photo luminescent materials, color change materials or wavelength downconverters.

As shown by FIGS. 7 and 9, in the example illustrated, pixels 190 are configured to emit different portions of the electromagnetic spectrum such as different wavelengths of light or different colors as compared to one another upon being impinged or irradiated by near-UV light that has been transmitted through PDLC matrix 124. In the particular example shown, pixels 190 include pixels 192 of photo luminescent material configured to emit red light upon being irradiated by near-UV light, pixels 194 are configured to emit green light upon being irradiated by near-UV light and pixels 196 are configured to emit blue light upon being irradiated by near-UV light. As shown by FIG. 9, pixels 192, 194 and 196 are arranged in an off-set pattern relative to one another such that a first pixel configured to emit a particular color is not located side-by-side another pixel configured to emit the same color. This pattern facilitates selective activation of pixels 192,194 and 196 to provide a multi-colored display. In other embodiments, pixels 192, 194 and 196 may have other patterns or may be configured to emit other colors of light.

As shown by FIG. 7, pixels 190 are formed by patterning photo luminescent materials upon a transparent dielectric substrate 198. In the particular example illustrated, substrate 198 may comprise a panel or sheet of glass. In another embodiment, substrate 198 may comprise a panel or sheet of other transparent dielectric material such as a transparent polymer material. As shown by FIG. 4, in one embodiment, substrate 198 may also serve as a substrate upon which electrode 122 is formed. According to one embodiment, substrate 198 has a thickness of about 2 mm to space pixels 190 from cells 184 and PDLC 182. In other embodiments, substrate 198 and electrode 122 may have other thicknesses to space pixels 190 from PDLC 182. In still other embodiments, substrate 198 may be omitted, wherein pixels 190 are patterned directly upon electrode 122 or wherein pixels 190 are patterned upon another structure such as film 134 (shown in FIG. 4).

As shown by FIG. 7, each of pixels 190 extends opposite to and generally corresponds to an individual cell 184 containing PDLC 182, wherein the cells 184 of PDLC 182 extend opposite and correspond to individual electrodes 150. In the particular embodiment illustrated, each of pixels 190 has a surface area of at least 2 um×6 um, of less than or equal to 1 mm×3 mm and nominally about 100 um×300 um. In the particular embodiment illustrated, each of pixels 190 as a shape and dimension corresponding to shapes and dimensions of cells 184 of grid 180 and electrodes 150. In other embodiments, pixels 190 may have shapes or dimensions differing from that of cells 184 or electrodes 150. Although pixels 190 are illustrated as having a square geometry and as being arranged in rows and columns, pixels 190 may alternatively have other surface geometries and may have other arrangements.

In operation, a controller such as controller 32 (shown and described with respect to FIG. 1) generates control signals directing a voltage source, such as voltage source 30 (shown and described with respect to FIG. 1) to transmit a voltage along data lines 158 (shown in FIG. 6) and to selectively transmit voltage along signal lines 160 (shown in FIG. 6) to selectively actuate switching devices 162 (shown in FIG. 6) between open and closed states to selectively charge individual electrodes 150. Those electrodes 150 which are charged establish a voltage or electric field across their respective cells 184 containing PDLC 182. As a result, the PDLC 182 in such cells 184 exhibits increased transmittance such that near-UV light emitted by light source 114 passes through such cells 184 and impinges upon corresponding opposite pixels 190. At the same time, those electrodes 150 which are not charged as a result of switching devices 162 remaining in an open state do not apply an electric field across PDLC 182 of their respective opposite cells 184 or create a lesser electric field such that the PDLC 182 within such cells 184 has a lower transmittance. As a result, the PDLC 182 in which a lesser electric field is applied, attenuates near-UV light from light source 114 to a greater extent. Consequently, pixels 190 aligned and generally opposite to those cells 184 containing light attenuating PDLC 182 are irradiated with less near-UV light and emit a lower intensity of light or no light. By selectively charging electrodes 150, the controller, such as controller 32, shown in FIG. 1, may selectively cause pixels 192, 194 and 196 to be irradiated by different levels of near-UV light such that such pixels 192, 194 and 196 emit different intensities of red, green and blue light, respectively, to produce a desired color image or display.

Film 134 comprises one or more layers of translucent material configured to overlie and protect photo luminescent pixels 190 of photo luminescent matrix 128. In particular embodiments, film 134 may additionally include other optical materials configured to enhance light emitted by display 110. Frame 136 comprises a structure configured to cooperate with frame 144 so as to rigidify and secure intermediate components of display 110 and to potentially facilitate mounting of display 110 to other structures. In particular embodiments, film 134 and frame 136 may be omitted or may have other configurations.

Overall, display 110 provides a display image that exhibits relatively high levels of brightness and high levels of contrast. Display 110 provides an emissive type display and operates at relative low voltages and with relatively fast response times. At the same time, display system 10 may be configured so as to be flexible, facilitating display system 10 for use in touch screen applications.

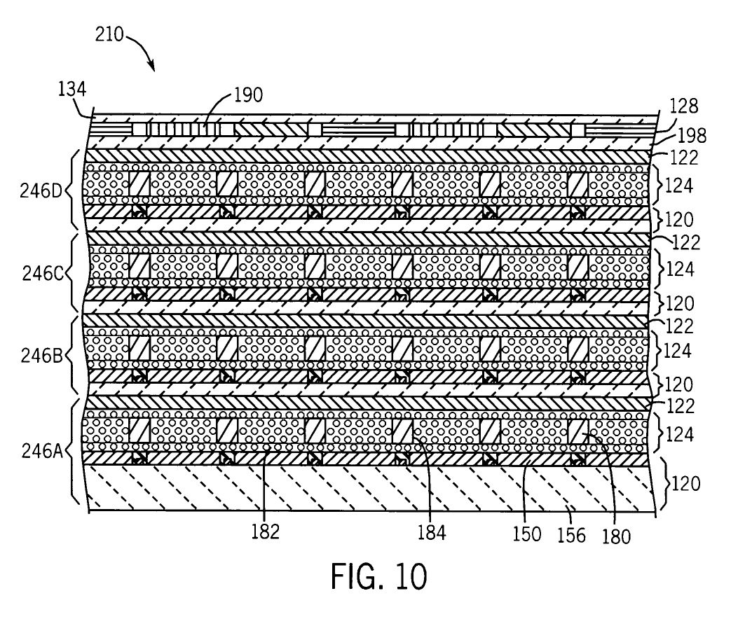

FIG. 10 is a sectional view schematically illustrating display system 210, another embodiment of display system 10. Display system 210 is similar to display system 110 (shown and described with respect to FIGS. 4-9) except that display system 210 includes a stack of shutters or modulators 246A, 246B, 246C and 246D (collectively referred to as modulators 246) in lieu of a single modulator 146 as shown in FIG. 7. Those remaining components of display system 210 correspond to the components of display system 110. For example, display system 210 also includes substrate 198, photo luminescent matrix 128 and film 134 (shown and described with respect to display system 110). Although not illustrated in FIG. 10, display system 210 additionally includes light source 114, diffuser 116 and frame 136 (shown and described with respect to FIG. 4). Modulators 246 are each configured to selectively attenuate near-UV light emitted by light source 114 (shown in FIG. 4) prior to such near-UV irradiating pixels 190 of photo luminescent matrix 128. Modulators 246 are each substantially similar to modulator 146 (shown and described in FIG. 7 with respect to display 110). In particular, each modulator 246 includes electrode matrix 120, electrode 122 and PDLC matrix 124. As noted with respect to display 110, in some embodiments, PDLC matrix 124 may omit grid 180.

Modulators 246 cooperate with one another to selectively attenuate light and to selectively permit transmission of near-UV light from light source 114 (shown in FIG. 4) to pixels 190 of photo luminescent matrix 128. Because modulators 246 are stacked, the individual thicknesses of PDLC matrix 124 of each of modulators 246 may be reduced while maintaining the total or collective thickness of PDLC 182 between light source 114 (shown in FIG. 4) and photo luminescent matrix 128. By reducing the thickness of each individual PDLC matrix 124, electrodes 150 may be more closely spaced to electrodes 122 of each modulator 246. This reduced spacing between electrodes 150 and 122 of each modulator 246 may reduce the operating voltages used to actuate PDLC 182 between different transmittance states while substantially maintaining or reducing by a relatively small amount the responsiveness of cells 184 containing PDLC 182 to actuate between different transmittance states. By maintaining the overall or collective thickness of PDLC 182, the collectively ability of modulators 246 to attenuate near-UV light prior to such light irradiating photo luminescent matrix 128 is also maintained or reduced by a relatively small amount as compared to a single photo luminescent matrix 124 having the same thickness. As a result, the contrast of display 210 is substantially maintained.

According to one example embodiment, each PDLC matrix 124 of modulators 246 (A-D) has a thickness of less than or equal to about 2 microns. In other embodiments, each PDLC matrix 124 may have greater thicknesses or reduced thicknesses. Although display 210 is illustrated as including four stacked modulators 246, display system 10 may alternatively include a greater or fewer number of such stacked modulators.

According to one embodiment, aligned electrodes 150 of modulators 246 are electrically connected to a voltage source so as to be substantially charged to the same voltage such that PDLC 182 in aligned cells 184 of modulators 246 all exhibit the same transmittance as one another. In other embodiments, electrodes 150 of modulators 246 that are aligned with one another may alternatively be electrically connected to a voltage source and a controller, such as controller to alternatively independently charge electrodes 150 to distinct voltages as compared to one another. By varying the charge applied to different aligned electrodes 150, the controller of display 210 may adjust and control the extent to which near-UV light is attenuated by the aligned set of electrodes 150 so as to also adjust and control the extent to which the aligned pixel 190 is irradiated by the near-UV light and the intensity of the light emitted by the particular pixel 190.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

1. An apparatus comprising:
a first transparent conductor;
a second transparent conductor;
a first polymer dispersed liquid crystal having liquid crystal droplets with a diameter of less than or equal to 800 nanometers, between the first conductor and the second conductor;
a near-UV light source on a first side of the first polymer dispersed liquid crystal; and
a photo luminescent material on a second opposite of the first polymer dispersed liquid crystal.

2. (canceled)

3. The apparatus of claim 1, wherein the first polymer dispersed liquid crystal has a thickness between the first conductor and the second conductor of less than or equal to about 20 micrometers.

4. The apparatus of claim 3, wherein the thickness is greater than or equal to about 2 micrometers.

5. The apparatus of claim 1 further comprising:
a third transparent conductor; and
a second polymer dispersed liquid crystal between the second conductor and the third conductor, the second polymer dispersed liquid crystal having liquid crystal droplets with a diameter of less than or equal to 800 nanometers.

6. The apparatus of claim 5 further comprising:
a fourth transparent conductor; and
a third polymer dispersed liquid crystal between the third conductor and the fourth conductor, the third polymer dispersed liquid crystal having liquid crystal droplets with diameters less than or equal to 800 nanometers.

7. The apparatus of claim 1 further comprising:
a matrix including cells containing the first polymer dispersed liquid crystal.

8. The apparatus of claim 7, wherein each cell includes light-absorbing sides.

9. The apparatus of claim 7, wherein the matrix is dielectric.

10. The apparatus of claim 7, wherein the first polymer dispersed liquid crystal continuously extends within a first one of the cells to within a second adjacent one of the cells.

11. The apparatus of claim 7, wherein the matrix is flexible.

12. The apparatus of claim 7, further comprising a photo luminescent material including pixels, each pixel corresponding to and substantially aligned with one of the cells.

13. The apparatus of claim 12, wherein the pixels include a first pixel configured to emit a first wavelength of electromagnetic radiation and a second pixel configured to emit a second wavelength of electromagnetic radiation.

14. The apparatus of claim 12, wherein the pixels include a first pixel configured to emit red light, a second pixel configured to emit green light and a third pixel configured to emit blue light.

15. The apparatus of claim 1, wherein the liquid crystal droplets have a diameter of less than or equal to about 500 nanometers.

16. The apparatus of claim 1, wherein the first transparent conductor includes a matrix of electrodes and wherein the apparatus further comprises a matrix of switch devices electrically coupled to the matrix of electrodes.

17. A display comprising:
means for emitting a first portion of an electromagnetic spectrum having wavelengths of less than or equal to about 500 nanometers;
means of selectivity attenuating the emitted portions using a polymer dispersed liquid crystal having liquid crystal droplets with a diameter of less than or equal to 800 nanometers; and
means for emitting a second portion of the electromagnetic spectrum in response to being impinged by the first portion.

18. (canceled)

19. (canceled)

20. (canceled)

21. (canceled)

22. (canceled)

23. (canceled)

24. (canceled)

25. (canceled)

26. (canceled)

27. The display of claim 17, wherein the means for selectively attenuating includes liquid crystal droplets with a diameter of less than or equal to 500 nanometers.
